(19) United States
(12) Patent Application Publication
(10) Pub. No.: US 2023/0055093 A1
(43) Pub. Date: Feb. 23, 2023

(54) CARTRIDGE AND AEROSOL GENERATING DEVICE COMPRISING THE SAME

(71) Applicant: KT&G CORPORATION, Daejeon (KR)

(72) Inventors: Sung Jong KI, Daejeon (KR); Young Joong KIM, Daejeon (KR); In Su PARK, Seoul (KR); John Tae LEE, Daejeon (KR); Sun Hwan JUNG, Daejeon (KR); Eun Mi JEOUNG, Daejeon (KR)

(73) Assignee: KT&G CORPORATION, Daejeon (KR)

(21) Appl. No.: 17/281,338

(22) PCT Filed: Dec. 29, 2020
(86) PCT No.: PCT/KR2020/019301

§ 371 Date: Oct. 31, 2022

(30) Foreign Application Priority Data
Feb. 25, 2020 (KR) 10-2020-0023008

(51) Int. Cl. A24F 40/465; A24F 40/42; A24F 40/10; A24F 40/20; A24F 40/30; A24F 40/51; A24F 40/46; H05B 6/10; H05B 11/00

(52) U.S. Cl. CPC A24F 40/465; A24F 40/42; A24F 40/10; A24F 40/20; A24F 40/30; A24F 40/51; A24F 40/46; H05B 6/108; H05B 11/00; H05B 2203/021

(57) ABSTRACT

A cartridge includes a liquid portion, a first heater arranged on one side of the liquid portion to heat the liquid portion, a medium portion, and a second heater surrounding at least a portion of the medium portion to heat the medium portion. The first heater is porous, the first heater and the second heater are induction heating-type heaters, an aerosol generated by heating the liquid portion passes through the first heater and flows toward the medium portion, and the aerosol passing through the medium portion is discharged from one end portion of the medium portion.

### TECHNICAL FIELD

One or more embodiments of the present disclosure relate to a cartridge and an aerosol generating device including the same, and more specifically, to a cartridge generating an aerosol through a plurality of induction heating-type heaters and an aerosol generating device including a body portion including the cartridge and an induction coil generating an induced magnetic field.

### BACKGROUND ART

Recently, the demand for alternative methods to overcome the shortcomings of general aerosol generating articles has increased. For example, there is an increasing demand for a method of generating aerosol by heating an aerosol generating material in aerosol generating articles, rather than by burning aerosol generating articles. Accordingly, studies on a heating-type aerosol generating article or a heating-type aerosol generating device have been actively conducted.

### DESCRIPTION OF EMBODIMENTS

### Technical Problem

An aerosol generating device heats an aerosol generating article through a heater, and a user inhales the aerosol through the heated aerosol generating article. In that case, an existing aerosol generating device generates an aerosol with one heater or with a plurality of heaters being individually controlled.

The existing aerosol generating device that controls one heater or individually controls a plurality of heaters may generate negative flavors such as burnt taste due to insufficient heat exchange within the aerosol generating device, and may cause discomfort to the user due to a delayed long heating time for reaching a temperature to generate an aerosol.

One or more embodiments of the present disclosure provide a cartridge generating an aerosol through a plurality of induction heating-type heaters controlled by an induction coil generating an induced magnetic field.

One or more embodiments of the present disclosure also provide a cartridge and an aerosol generating device including a body portion accommodating the cartridge and including an induction coil.

Technical goals to be achieved with reference to the embodiments are not limited to the above-described coals, and the goals that are not mentioned will be clearly understood by one of ordinary skill in the art from the present specification and the accompanying drawings.

### Solution to Problem

The cartridge according to one or more embodiments of the present disclosure includes: a liquid portion; a first heater arranged on one side of the liquid portion to heat the liquid portion; a medium portion; and a second heater surrounding at least a portion of the medium portion to heat the medium portion, wherein the first heater is porous, the first heater and the second heater are induction heating-type heaters, an aerosol generated by heating the liquid portion passes through the first heater and flows toward the medium portion, and the aerosol passing through the medium portion is discharged from one end portion of the medium portion.

### Advantageous Effects of Disclosure

The cartridge according to one or more embodiments includes a plurality of induction heating-type heaters. The plurality of induction heating-type heaters of the cartridge may be simultaneously heated by an induction coil generating an induced magnetic field.

As the plurality of induction heating-type heaters of the cartridge are simultaneously heated by the induction coil, each heater may be preheated to a certain temperature. Therefore, it is possible to reduce a heating time for each heater to reach a temperature for generating an aerosol. The reduction of the heating time for each heater may allow faster aerosol generation within the cartridge, and may decrease a waiting time for a user to use an aerosol generating device, thereby increasing user convenience.

The aerosol generated from the cartridge according to one or more embodiments may actively exchange heat within the cartridge. Therefore, the cartridge may generate an aerosol having a rich amount of mist to increase the user's smoking satisfaction, and may prevent negative flavors such as burnt taste from being contained in the aerosol.

The aerosol generating device according to one or more embodiments includes the above-described cartridge and a body portion. The aerosol generated from the cartridge passes through an airflow path within the aerosol generating device to be provided to the user. The aerosol generating device may include a puff detection sensor. When the puff detection sensor is used, a response speed of a heater of the cartridge may be increased, thereby increasing an aerosol generation speed.

### BRIEF DESCRIPTION OF DRAWINGS

FIG. 1A is a cross-sectional view of an aspect of a cartridge, according to embodiments.

FIG. 1B is a perspective view of another aspect of a cartridge, according to embodiments.

FIG. 2A is a perspective view of an aerosol generating device, according to embodiments.

FIG. 2B is a cross-sectional view of the aerosol generating device illustrated in FIG. 2A.

FIG. 3 is a cross-sectional view illustrating an airflow path through which an aerosol flows within an aerosol generating device according to embodiments.

### BEST MODE

The cartridge according to one or more embodiments of the present disclosure includes: a liquid portion; a first heater arranged on one side of the liquid portion to heat the liquid portion; a medium portion; and a second heater surrounding at least a portion of the medium portion to heat the medium portion, wherein the first heater is porous, the first heater and the second heater are induction heating-type heaters, an aerosol generated by heating the liquid portion passes through the first heater and flows toward the medium portion, and the aerosol passing through the medium portion is discharged from one end portion of the medium portion.

The medium portion may be heated by the second heater to add flavor to the aerosol passing through the medium portion.

The medium portion may be located away from the first heater in a longitudinal direction of the cartridge.

The liquid portion may include a storage tank for storing a liquid composition.

The liquid portion may be formed of a wrapper for containing the liquid composition.

The aerosol generating device according to one or more embodiments may include a body portion accommodating the cartridge and including an induction coil generating an induced magnetic field to heat the first heater and the second heater of the cartridge.

The induction coil may extend in a longitudinal direction of the body portion to apply an induced magnetic field to both the first heater and the second heater.

The first heater and the second heater may be heated to 60° C. to 180° C. in a preheating mode of the aerosol generating device.

The first heater may be heated to 150° C. to 300° C. higher than a temperature of the second heater in a heating mode of the aerosol generating device.

The medium portion may include a first medium portion surrounded by the second heater and a second medium portion not surrounded by the second heater, and a through hole through which an aerosol is discharged may be formed around the second medium portion.

The body portion may further include a mouthpiece portion, and the aerosol discharged from the cartridge through the through hole may flow to the mouthpiece portion to be delivered to a user.

The mouthpiece portion may be located on a side opposite the medium portion with respect to the liquid portion.

A partition wall may be arranged between the cartridge and the induction coil, and the aerosol may flow to the mouthpiece portion through an airflow path between the cartridge and the partition wall.

The body portion may further include a puff detection sensor for detecting the user's inhalation.

The puff detection sensor may be located within the airflow path.

The first heater may be an electric resistive heater, and may include a susceptor material to be heated through induction heating.

### MODE OF DISCLOSURE

With respect to the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In addition, terms used in the present specification are for describing the embodiments and are not intended to limit the embodiments. In the present specification, the singular form also includes the plurality form unless specifically stated in the phrase.

Throughout the specification, the “longitudinal direction” of a component may be a direction in which the component extends along an axis in one direction of the component, wherein the axis in one direction of the component extends longer than an axis in the other direction of the component crossing the axis in one direction of the component.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

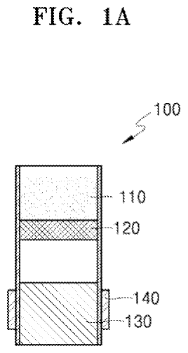

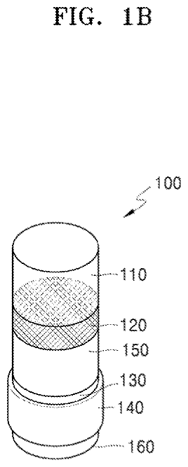

FIG. 1A is a cross-sectional view of an aspect of a cartridge 100, according to embodiments.

The cartridge 100 according to embodiments includes a liquid portion 110, a first heater 120 arranged on one side of the liquid portion 110 to heat the liquid portion 110, a medium portion 130, and a second heater 140 surrounding at least a portion of the medium portion 130 to heat the medium portion 130.

The cartridge 100 according to embodiments may heat the liquid portion 110 to generate an aerosol. The liquid portion 110 may include a storage tank for storing a liquid composition. The liquid composition may be, for example, a liquid containing a tobacco-containing substance including a scented tobacco component, or may be a liquid containing a non-tobacco substance. The liquid portion 110 may be manufactured to be detachably attached to the cartridge 100, or may be manufactured integrally with the cartridge 100.

The liquid composition may include an aerosol generating material. For example, the liquid composition may include at least one of glycerin, propylene glycol, ethylene glycol, dipropylene glycol, diethylene glycol, triethylene glycol, tetraethylene glycol, and oleyl alcohol, but is not limited thereto.

The liquid composition may further include other additive substances such as a flavoring agent, a wetting agent and/or organic acids. The liquid composition may further include a flavoring liquid such as menthol or a moisturizer. For example, the liquid composition may include water, solvent, ethanol, plant extracts, a fragrance, a flavoring agent, or a vitamin mixture. The fragrance may include menthol, peppermint, spearmint oil, various fruit flavoring ingredients, and the like, but is not limited thereto. The flavoring agent may include ingredients that may provide a variety of flavors to a user.

The first heater 120 for heating the liquid portion 110 may be arranged adjacent to the liquid portion 110, as an element for heating the liquid composition. As an example, the first heater 120 may be arranged on one side of the liquid portion 110 so as to directly contact the liquid composition within the liquid portion 110.

One end portion of the liquid portion 110 may be surrounded by the first heater 120 such that the liquid composition stored in the liquid portion 110 flows to the first heater 120. In that case, an opening capable of allowing liquid flows toward the first heater 120 may be formed at one end portion of the liquid portion 110, and a size of the opening may be changed if necessary. For example, the size of the opening may be equal to that of the one end portion of the liquid portion 110.

When the first heater 120 is arranged to contact the liquid composition, the first heater 120 may be formed to be porous so as to absorb the liquid composition and contain the same for a certain period of time. That is, the first heater 120 may heat the liquid composition while maintaining the same.

The first heater 120 may be formed in a mesh shape in which a plurality of through holes are formed. The liquid composition may be contained within the first heater 120 and heated to be vaporized into an aerosol, and the vaporized aerosol may pass through the porous first heater 120.

The first heater 120 may be a porous metal heating wire, a metal heating plate, a ceramic heater, or the like, but is not limited thereto. In addition, the first heater 120 may be formed of a conductive filament such as a nichrome wire. The first heater 120 may be heated by electromagnetic induction. The first heater 120 may transfer heat to the liquid composition in contact to heat the liquid composition. As a result, an aerosol may be generated. The first heater 120 may be a cartridge heater that heats the liquid composition. The first heater 120 may be a common electric resistive heater, and may include a susceptor material capable of being heated through induction heating.

As another example, the first heater 120 may be arranged to contact a delivery means which is arranged within the liquid portion 110 and absorbs the liquid composition. For example, the delivery means may be a wick such as cotton fiber, ceramic fiber, glass fiber, or porous ceramic, but is not limited thereto. The first heater 120 may contact the liquid composition through the delivery means for absorbing the liquid composition.

In that case, the first heater 120 may be a metal heating wire, a metal heating plate, a ceramic heater, or the like, and the first heater 120 may include a conductive filament such as a nichrome wire, or may be arranged in a structure wound around the delivery means. The first heater 120 may transfer heat to the liquid composition absorbed by the delivery means to heat the liquid composition. As a result, the liquid composition may be vaporized from the delivery means to produce an aerosol.

The second heater 140 of the cartridge 100 according to embodiments may heat the medium portion 130. The medium 130 may be heated by the second heater 140 to add flavor to the aerosol passing through the medium portion 130.

The medium portion 130 may include a tobacco material containing nicotine. The nicotine of the medium portion 130 may not be nicotine included in the tobacco material obtained by shaping or reconstituting of tobacco leaves, but may be nicotine that is naturally generated or synthetic nicotine. For example, the nicotine may include one of free base nicotine, nicotine salt, or a combination thereof.

The medium portion 130 may be manufactured in various ways. The medium portion 130 may be made of a sheet or a strand. The medium portion 130 may also be made of cut fillers obtained by finely cutting a tobacco sheet.

The medium portion 130 may be arranged away from the first heater 120 in a longitudinal direction of the cartridge 100. That is, the liquid portion 110, the first heater 120, and the medium portion 130 within the cartridge 100 may be arranged along the longitudinal direction of the cartridge 100. When the liquid portion 110 and the first heater 120 are arranged to contact each other, the medium portion 130 and the first heater 120 may be arranged away from each other by a certain distance.

The second heater 140 may heat the medium portion 130. The second heater 140 may be arranged to surround at least a portion of the medium portion 130. For example, the second heater 140 may surround at least a portion of the medium portion 130 along an outer circumference of the medium portion 130 and extend in the longitudinal direction of the cartridge 100. In that case, a length in which the second heater 140 extends may be within a range of length corresponding to the medium portion 130.

The second heater 140 may be a metal heating wire, a metal heating plate, a ceramic heater, or the like, but is not limited thereto. In addition, the second heater 140 may be formed of a conductive filament such as nichrome wire. The second heater 140 may be heated by electromagnetic induction. The second heater 140 may heat the medium portion 130 such that the medium 130 portion has a temperature within a certain range or higher.

The medium portion 130 may add flavor to the aerosol generated by heating the liquid portion 110. The medium 130 may not only be heated by the second heater 140, but also may be heated by heat transferred through the flow of the generated aerosol.

For example, the medium portion 130 may be heated to a certain temperature or higher by the second heater 140. Following that, the aerosol generated by heating the liquid composition stored in the liquid portion 110 may pass through the medium portion 130. The aerosol passing through the medium portion 130 may exchange heat with the medium portion 130, and the medium portion 130 may discharge a flavoring substance such as nicotine into the flowing aerosol through heat exchange with the aerosol.

The flavoring substance released into the aerosol may be contained in the aerosol to add flavor to the aerosol. The aerosol passing through the medium portion 130 may be discharged from one end portion of the medium portion 130, and the discharged aerosol may be absorbed by the user.

FIG. 1B is a perspective view of another aspect of the cartridge 100, according to embodiments.

In another aspect of the cartridge 100 according to embodiments, the cartridge 100 may be formed as a cigarette. In that case, the liquid portion 110 may be formed of a wrapper for containing a liquid composition. For example, the liquid portion 110 may be formed of a crimped sheet, and the liquid composition may be included in the liquid portion 110 while being impregnated with the crimped sheet. Other additive substances such as a flavoring agent, a wetting agent and/or organic acids and a flavoring liquid may also be included in the liquid portion 110 while being absorbed by the crimped sheet.

The crimped sheet forming the liquid portion 110 may be a sheet made of a polymer material. For example, the polymer material may include at least one of paper, cellulose acetate, lyocell, and polylactic acid. For example, the crimped sheet may be a paper sheet that does not cause off-flavor due to heat even when heated to a high temperature. However, embodiments of the present disclosure are not limited thereto.

The liquid composition contained in the wrapper may include an aerosol generating material. For example, the liquid composition may include at least one of glycerin, propylene glycol, ethylene glycol, dipropylene glycol, diethylene glycol, triethylene glycol, tetraethylene glycol, and oleyl alcohol, but is not limited thereto.

The first heater 120 for heating the liquid portion 110 may be arranged adjacent to the liquid portion 110, as an element for heating the liquid composition. For example, the first heater 120 may heat the wrapper containing the liquid composition, and the wrapper and the first heater 120 may contact each other.

The first heater 120 may be formed in a porous mesh shape in which a plurality of through holes are formed. The liquid composition may be heated by the first heater 120 and vaporize into an aerosol, and the vaporized aerosol may pass through the porous first heater 120.

The first heater 120 may be a porous metal heating wire, a metal heating plate, a ceramic heater, or the like, but is not limited thereto. In addition, the first heater 120 may be formed of a conductive filament such as a nichrome wire. The first heater 120 may be heated by electromagnetic induction. The first heater 120 may transfer heat to the wrapper in contact, and the liquid composition contained in the heated wrapper may be heated to generate an aerosol.

In another aspect of the cartridge 100 according to embodiments, when the cartridge 100 is formed as a cigarette, the medium portion 130 may be heated by the second heater 140 to add flavor to the aerosol passing through the medium portion 130.

The medium portion 130 and the second heater 140 shown in FIG. 1B have the same configuration and effect as the medium portion 130 and the second heater 140 shown in FIG. 1A. Therefore, redundant detailed descriptions thereof will be omitted.

The medium portion 130 may be arranged away from the first heater 120 in a longitudinal direction of the cartridge 100. In that case, a cooler 150 may be arranged between the first heater 120 and the medium portion 130. The cooler 150 may be made of, for example, cellulose acetate, and may be a tube-shaped structure including a hollow therein. The cooler 150 may be manufactured by adding a plasticizer (e.g., triacetin) to a cellulose acetate tow.

The cooler 150 may be made of paper, and may be a tube-shaped structure including a hollow therein. However, a shape of the cooler 150 is not limited to the above-described example, and there are no limitations on the shape of the cooler 150 as long as it is able to perform a function of cooling the aerosol.

In another aspect of the cartridge 100 according to embodiments, when the cartridge 100 is formed of a cigarette, a filter portion 160 may be arranged on the other side of the medium portion 130. The other side of the medium portion 130 may refer to a direction away from the liquid portion 110 with respect to the other side of the medium portion 130.

The filter portion 160 may be manufactured by adding a plasticizer (e.g., triacetin) to a cellulose acetate tow. The filter portion 160 may be manufactured to generate flavor. As an example, a fragrance liquid may be sprayed onto the filter portion 160, or a separate fiber coated with the fragrance liquid may be inserted into the filter portion 160.

In addition, at least one capsule may be included in the filter portion 160. Here, the capsule may serve to generate flavor, or may serve to generate an aerosol. For example, the capsule may have a structure in which a liquid containing fragrance is wrapped with a film. The capsule may have a spherical or cylindrical shape, but is not limited thereto.

When the filter portion 160 is arranged on the other side of the medium portion 130, the aerosol may be absorbed by a user through the filter portion 160. For example, the wrapper containing the liquid composition may be heated by the first heater 120 and then an aerosol may be generated.

The aerosol may be cooled while passing through the cooler 150. The medium portion 130 may add flavor to the cooled aerosol while passing through the cooler 150. The medium portion 130 may not only be heated by the second heater 140, but also may be heated by heat transferred by the flow of the aerosol.

The aerosol passing through the medium portion 130 may exchange heat with the medium portion 130, and the medium portion 130 may discharge a flavoring substance such as nicotine into the flowing aerosol through heat exchange with the aerosol.

The aerosol passing through the medium portion 130 may then pass through the filter portion 160. The filter portion 160 may contact the user's mouth. The aerosol passing through the filter portion 160 may be provided to the user.

Although not shown in FIG. 1B, the cartridge 100 formed of a cigarette may include a wrapper wrapping the cigarette, and each component of the cartridge 100 may include a separate wrapper. At least one hole may be formed in the wrapper through which air flows in from the outside or gas flows out of the inside.

For example, the liquid portion 110 and the first heater 120 may be packaged by a first wrapper, the cooler 150 may be packaged by a second wrapper, the medium portion 130 may be packaged by a third wrapper, the filter portion 160 may be packaged by a fourth wrapper, and the first wrapper, the second wrapper, the third wrapper, and the fourth wrapper may be packaged by a fifth wrapper.

The second heater 140 that heats the medium portion 130 may be packaged by the third wrapper. Alternatively, the second heater 140 may be arranged to surround the medium portion 130 from the outside of the fifth wrapper wrapping the cigarette.

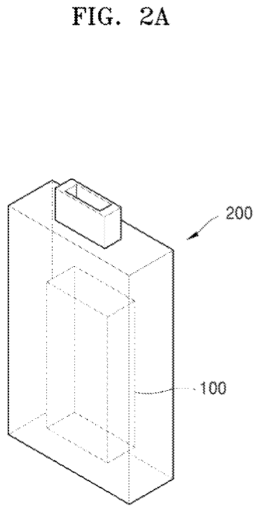

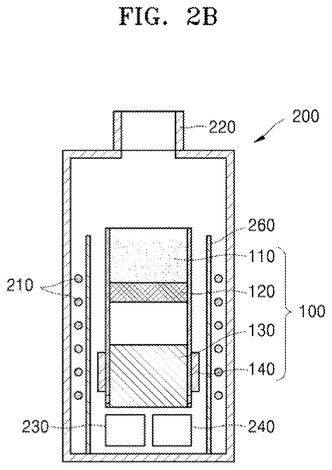

FIG. 2A is a perspective view of an aerosol generating device 200 according to embodiments, and FIG. 2B is a cross-sectional view of the aerosol generating device 200 illustrated in FIG. 2A.

The aerosol generating device 200 according to embodiments may include the cartridge 100 and a body portion accommodating the cartridge 100 and including an induction coil 210 generating an induced magnetic field to heat the first heater 120 and the second heater 140.

The body portion of the aerosol generating device 200 may accommodate the cartridge 100. For example, the cartridge 100 may be accommodated in the body portion in a lengthwise direction of the body portion, or may be inserted into the body portion in a direction transverse to the lengthwise direction of the body portion.

The body portion may include the induction coil 210 generating an induced magnetic field to heat the first heater 120 and the second heater 140 of the cartridge 100. The induction coil 210 may extend in the longitudinal direction of the body portion so as to apply an induced magnetic field to both the first heater 120 and the second heater 140 of the cartridge 100.

The induction coil 210 of the body portion may be wound along a side of a space in which the cartridge 100 is accommodated to generate an induced magnetic field, and the first heater 120 and the second heater 140 may be arranged at a position corresponding to the position of the induction coil 210 to generate heat by the induced magnetic field generated by the induction coil 210. The induction coil 210 may be located a certain distance away from the space in which the cartridge 100 is accommodated. A partition wall 260 may be formed between the induction coil 210 and the space in which the cartridge 100 is accommodated.

When an alternating magnetic field is applied to a magnetic material, energy loss may occur in the magnetic material due to eddy current loss and hysteresis loss, and the lost energy may be released from the magnetic material as thermal energy. The greater an amplitude or frequency of the alternating magnetic field applied to the magnetic material, the more thermal energy released from the magnetic material.

According to embodiments, the first heater 120 and the second heater 140 may be susceptors heated by the induced magnetic field. The first heater 120 and the second heater 140 may include metal or carbon. The first heater 120 and the second heater 140 may include at least one of ferrite, ferromagnetic alloy, stainless steel, and aluminum (Al). Alternatively, the first heater 120 and the second heater 140 may include at least one of ceramics such as graphite, molybdenum, silicon carbide, niobium, nickel alloy, metal film, zirconia, and the like, transition metals such as nickel (Ni), cobalt (Co), or the like, and metalloids such as boron (B) or phosphorus (P).

Although not shown, the body portion may include a battery 230 and a controller 240. The induction coil 210 may receive power from the battery 230. The controller 240 may generate a magnetic field by controlling an electrical current flowing through the induction coil 210, and an induced current may be generated in the first heater 120 and the second heater 140 by the influence of the magnetic field. Such an induction heating phenomenon is a known phenomenon described by Faraday's Law of induction and Ohm's Law, and refers to a phenomenon in which, when magnetic induction changes within a conductor, a changing electric field is generated within the conductor.

As described above, by generating an electric field within the conductor, eddy current flows within the conductor according to Ohm's law, and the eddy current generates heat proportional to a current density and conductor resistance.

In other words, when power is supplied to the induction coil 210, a magnetic field may be generated within the induction coil 210. When an alternating current is applied to the induction coil 210 from the battery 230, the magnetic field formed within the induction coil 210 may periodically change its direction. When the first heater 120 and the second heater 140 are exposed to the alternating magnetic field formed within the induction coil 210 and changing periodically its direction, the first heater 120 and the second heater 140 may generate heat, thereby heating the cartridge 100 accommodated in the body portion.

When an amplitude or frequency of the alternating magnetic field formed by the induction coil 210 changes, temperatures of the first heater 120 and the second heater 140 that heat the cartridge 100 may also change. The controller 240 may control power supplied to the induction coil 210 to regulate the amplitude or frequency of the alternating magnetic field formed by the induction coil 210, and accordingly the temperatures of the first heater 120 and the second heater may be controlled.

Within the aerosol generating device 200 according to embodiments, the first heater 120 and the second heater 140 may have temperature profiles according to a preheating mode. In the preheating mode, the first heater 120 and the second heater 140 may be heated to 60° C. to 180° C. The first heater 120 and the second heater 140 may have the same temperature in a preheating profile. As the first heater 120 and the second heater 140 have the temperature profiles according to the preheating mode, the first heater 120 and the second heater 140 may be rapidly heated in a heating mode, thereby increasing a response speed of the aerosol generating device 200.

The first heater 120 and the second heater 140 of the aerosol generating device 200 may also have temperature profiles according to the heating mode. In the heating mode, the first heater 120 and the second heater 140 may have the temperature profiles different from each other. The first heater 120 and the second heater 140 may have materials, shapes, and sizes different from each other. Therefore, in the heating mode, the first heater 120 and the second heater 140 may have the temperature profiles different from each other. In that case, the temperature of the first heater 120 may be higher than the temperature of the second heater 140, and the temperature of the first heater 120 may be 150° C. to 300° C.

As the first heater 120 is heated to 150° C. to 300° C. higher than the temperature of the second heater 140 in the heating mode, a liquid composition stored in the liquid portion 110 may be heated and then an aerosol may be generated.

In the heating mode, the temperature of the second heater 140 may be the same as in the preheating mode. That is, the second heater 140 may be heated to 60° C. to 180° C. The medium portion 130 may exchange heat with the second heater 140 and the generated aerosol. According to the heat exchange, the medium portion 130 may release a flavoring material to the aerosol, and accordingly the flavor may be contained in the aerosol.

As an example, the induction coil 210 may be implemented as a solenoid. A material of a conducting wire constituting the solenoid may be copper (Cu). However, embodiments of the present disclosure are not limited thereto, and the material of the conducting wire constituting the solenoid may be any one of silver (Ag), gold (Au), Al, tungsten (W), zinc (Zn), and nickel (Ni) which allow a high electrical current to flow with a low specific resistance value, or an alloy including at least one of them.

The battery 230 supplies power used for the body portion to operate. For example, the battery 230 may supply power to the induction coil 210 such that the first heater 120 and the second heater 140 are heated, and may supply power required for the controller 240 to operate. The battery 230 may also supply power required for a display, a sensor, a motor, and the like installed in the body portion to operate.

The controller 240 controls the overall operation of the body portion. For example, the controller 240 may control power supplied to the induction coil 210. The controller 240 also controls the operation of not only the battery 230 but also other components included in the body portion. In addition, the controller 240 may check states of each of the components of the body portion and determine whether or not the body portion is operable.

The controller 240 includes at least one processor. The processor may be implemented as an array of a plurality of logic gates or may be implemented as a combination of a general-purpose microprocessor and a memory in which a program executable in the microprocessor is stored. Those of ordinary skill in the art to which the present embodiment belongs may understand that the processor may also be implemented with other types of hardware.

Two or more heaters may be arranged in the body portion. In that case, the plurality of heaters may be arranged to be inserted into the cartridge 100, or may be arranged outside the cartridge 100. Alternatively, some of the plurality of heaters may be arranged to be inserted into the cartridge 100, and the rest may be arranged outside the cartridge 100. In addition, shapes of the heaters are not limited to those shown in the drawings, and the heaters may be manufactured in various shapes.

The body portion may further include a mouthpiece portion 220. The aerosol generated from the cartridge 100 may be provided to a user through the mouthpiece portion 220. When the cartridge 100 is formed of a cigarette, the aerosol may be discharged from an end portion of the cigarette rather than the mouthpiece portion 220 and provided to the user.

The body portion may further include general-purpose components other than the induction coil 210, the battery 230, and the controller 240. For example, the body portion may include a display capable of outputting visual information and/or a motor for outputting tactile information.

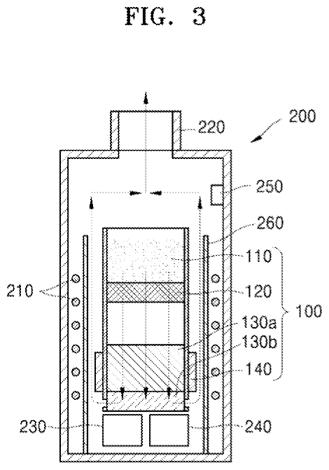

FIG. 3 is a cross-sectional view illustrating an airflow path through which an aerosol flows within the aerosol generating device 200 according to embodiments. Referring to FIG. 3, a flow of the aerosol within the aerosol generating device 200 may be identified in greater detail.

The aerosol generated from the cartridge 100 may be discharged from the cartridge 100 through one end portion of the medium portion 130. In that case, the medium portion 130 may include a first medium portion 130a surrounded by the second heater 140 and a second medium portion 130b not surrounded by the second heater 140, and a through hole through which the aerosol is discharged may be formed around the second medium portion 130b.

That is, the aerosol generated from the cartridge 100 is discharged from one end portion of the cartridge 100, and the aerosol may be discharged from the cartridge 100 through the through hole formed around the second medium portion 130b. The through hole formed around the second medium portion 130b may be formed, among outer walls of the cartridge 100, on an outer wall of the cartridge 100 surrounding the second medium portion 130b. In that case, there may be a plurality of through holes, and the plurality of through holes may be arranged away from each other.

The aerosol discharged from the cartridge 100 through the through hole may flow to the mouthpiece portion 220. The aerosol flowing to the mouthpiece portion 220 may be delivered to a user. The mouthpiece portion 220 may be located on a side opposite the medium portion 130 with respect to the liquid portion 110.

That is, the one end portion of the medium portion 130 from which the aerosol is discharged and the mouthpiece portion 220 may be located to face each other with respect to the liquid portion 110, and the aerosol discharged from the cartridge 100 may flow while passing through the cartridge 100 in a longitudinal direction of the cartridge 100. The aerosol flowing into the aerosol generating device 200 while passing through the cartridge 100 may pass through the mouthpiece portion 220.

Within the aerosol generating device 200 according to embodiments, the partition wall 260 may be formed between the cartridge 100 and the induction coil 210. In that case, an airflow path may be formed between the cartridge 100 and the partition wall 260, and the aerosol may flow to the mouthpiece portion 220 through the airflow path.

Within the aerosol generating device 200 according to embodiments, a body portion may include at least one sensor (puff detection sensor, temperature detection sensor, cartridge insertion detection sensor). In that case, the sensor may be a puff detection sensor 250, and the puff detection sensor 250 may be located within the airflow path.

The puff detection sensor 250 located within the airflow path may detect the user's inhalation. The puff detection sensor 250 may be electrically connected to the controller 240 within the body portion. When the inhalation of the user is detected by the puff detection sensor 250, the controller 240 may supply power to the induction coil 210. When power is supplied to the induction coil 210, a magnetic field may be formed in the induction coil 210, and the first heater 120 and the second heater 140 may be heated.

As a heating profile is changed according to the detection by the puff detection sensor 250, a response speed of the aerosol generating device 200 may be increased. Accordingly, it is possible to increase user convenience by reducing the user's waiting time.

The body portion may be manufactured as a structure in which air may flow in from the outside or gas may flow out of the inside even when the cartridge 100 is inserted into the body portion. As an example, air from the outside may flow in through at least one air passage formed within the body portion. For example, opening and closing of the air passage formed within the body portion and/or a size of the air passage may be regulated by the user. Accordingly, an amount of atomization and a smoking feeling may be regulated by the user.

The body portion may constitute a system with a separate cradle. For example, the cradle may be used to charge the battery 230 of the body portion. The first heater 120 and the second heater 140 may be heated while the cradle and the body portion are combined to each other.

The cartridge 100 according to embodiments includes a plurality of heating-type heaters. The plurality of heating-type heaters of the cartridge 100 may be simultaneously heated by the induction coil 210 generating an induced magnetic field, and accordingly each heater may be preheated to a certain temperature.

As the heaters are preheated to a certain temperature, a time required for the heaters to reach a temperature for generating an aerosol may be reduced. The reduction of the heating time for each heater may allow faster aerosol generation within the cartridge 100, and may reduce a waiting time for the user to use the aerosol generating device 200, thereby increasing user convenience.

The aerosol generated from the cartridge 100 according to embodiments may actively exchange heat within the cartridge 100. Therefore, the cartridge 100 may generate an aerosol having a rich amount of mist to increase the user's smoking satisfaction, and may prevent negative flavors such as burnt taste from being contained in the aerosol.

The aerosol generating device 200 may include the puff detection sensor 250. When the puff detection sensor 250 is used, a response speed of the heaters of the cartridge 100 may be increased, thereby increasing an aerosol generation speed.

Those of ordinary skill in the art related to the present embodiments may understand that various changes in form and details can be made therein without departing from the scope of the characteristics described above. The disclosed methods should be considered in a descriptive sense only and not for purposes of limitation. Therefore, the scope of the disclosure should be defined by the appended claims, and all differences within the scope equivalent to those described in the claims will be construed as being included in the scope of protection defined by the claims.

### INDUSTRIAL APPLICABILITY

One or more embodiments of the present disclosure relate to a cartridge generating an aerosol through a plurality of induction heating-type heaters and an aerosol generating device including a body portion including the cartridge and an induction coil generating an induced magnetic field.

1. A cartridge comprising:
a liquid portion;
a first heater arranged on one side of the liquid portion to heat the liquid portion;
a medium portion; and
a second heater surrounding at least a portion of the medium portion to heat the medium portion,
wherein the first heater is porous,
the first heater and the second heater are induction heating-type heaters,
an aerosol generated by heating the liquid portion passes through the first heater and flows toward the medium portion, and
the aerosol passing through the medium portion is discharged from one end portion of the medium portion.

2. The cartridge of claim 1, wherein the medium portion is heated by the second heater to add flavor to the aerosol passing through the medium portion.

3. The cartridge of claim 1, wherein the medium portion is arranged away from the first heater in a lengthwise direction of the cartridge.

4. The cartridge of claim 1, wherein the liquid portion comprises a storage tank for storing a liquid composition.

5. The cartridge of claim 1, wherein the liquid portion is formed of a wrapper for containing a liquid composition.

6. An aerosol generating device comprising:
the cartridge according to claim 1; and
a body portion accommodating the cartridge and comprising an induction coil generating an induced magnetic field to heat the first heater and the second heater of the cartridge.

7. The aerosol generating device of claim 6, wherein the induction coil extends in a lengthwise direction of the body portion to apply an induced magnetic field to both the first heater and the second heater.

8. The aerosol generating device of claim 6, wherein the first heater and the second heater are heated to 60° C. to 180° C. in a preheating mode of the aerosol generating device.

9. The aerosol generating device of claim 8, wherein, in a heating mode of the aerosol generating device, the first heater is heated to 150° C. to 300° C. higher than a temperature of the second heater.

10. The aerosol generating device of claim 6, wherein
the medium portion comprises a first medium portion surrounded by the second heater and a second medium portion not surrounded by the second heater, and
a through hole through which an aerosol is discharged is formed around the second medium portion.

11. The aerosol generating device of claim 10, wherein
the body portion further comprises a mouthpiece portion, and
the aerosol passing through the through hole and discharged from the cartridge flows to the mouthpiece portion to be delivered to a user.

12. The aerosol generating device of claim 11, wherein the mouthpiece portion is located on a side opposite the medium portion with respect to the liquid portion.

13. The aerosol generating device of claim 11, wherein
a partition wall is arranged between the cartridge and the induction coil, and
the aerosol flows to the mouthpiece portion through an airflow path between the cartridge and the partition wall.

14. The aerosol generating device of claim 13, wherein the body portion further comprises a puff detection sensor for detecting the user's inhalation.

15. The aerosol generating device of claim 6, wherein the first heater is an electric resistive heater, and comprises a susceptor material to be heated through induction heating.
